(19) United States
(12) Patent Application Publication
(10) Pub. No.: US 2010/0251383 A1
(43) Pub. Date: Sep. 30, 2010

(54) DATA CLOAKING METHOD AND APPARATUS

(76) Inventor: Mark R. Cosby, Middleburg, VA (US)

Correspondence Address: TAYLOR IP, P.C., P.O. Box 560, 142. S Main Street, Avilla, IN, 46710, US

(21) Appl. No.: 12/749,839

(22) Filed: Mar. 30, 2010

Related U.S. Application Data
(60) Provisional application No. 61/164,702, filed on Mar. 30, 2009.
(60) Provisional application No. 61/313,288, filed on Mar. 12, 2010.

(51) Int. Cl. H04K 1/00

(52) U.S. Cl. 726/26

(57) ABSTRACT

A method of cloaking data including the steps of recognizing a combination of unclassified information becoming classified as a result of the combination of the information; and cloaking of a portion of the information responsive to a classified authorization of at least one of receiving equipment and users. The recognizing step and the cloaking step being carried out by a data handling machine.

### CROSS REFERENCE TO RELATED APPLICATIONS

This is a non-provisional application based upon U.S. provisional patent application Ser. No. 61/164,702, entitled DATA CLOAKING METHOD AND APPARATUS″, filed Mar. 30, 2009, and U.S. provisional patent application Ser. No. 61/313,288, entitled “DATA CLOAKING METHOD AND APPARATUS”, filed Mar. 12, 2010, both of which are incorporated herein by reference.

### BACKGROUND OF THE INVENTION

1. Field of the Invention

The present invention relates to a data security protocol carried out with a computing apparatus, and, more particularly, to a data cloaking method executed in a data handling system.

2. Description of the Related Art

U.S. Pat. No. 6,999,876 discloses a modular architecture for rapid deployment and coordination of emergency event field surveillance including an emergency management system having a field device with global positioning system (GPS) capabilities. A geospatial portrayal server automatically generates updated graphical status reports and layered geospatial visual portrayals. In association with a database server, the field assessment database maintains a collection of baseline emergency response support data. Specifically, the field assessment database includes baseline layered geospatial visual portrayal and field surveillance attribute data. Sources of layered geospatial visual portrayal data include geographic information system (GIS), map data, and other digitized map data. The field surveillance attribute data includes data describing and/or identifying any person, resource, structure, device, or system that is observable by a field inspector as an object of field assessment efforts. A field surveillance attribute may include structural facilities such as hospitals, police stations, transportation structures such as roads and highways, vehicles, etc. The database server stores the field assessment report data locally, buffering and passing back to a requesting client only the data that meets the client's search criteria. The report is in layered geospatial visual portrayals generated by the database server in concert with the geospatial portrayal server may be delivered to or browser-retrieved by the client. The database server generates statistical and graphical information of interest to emergency managers. The event manager further includes a set of statistical processing tools that retrieve and process the event-specific records within the event file to generate output reports utilized by the EMC for event tracking purposes. The event manager further includes programs and instructions for defining the nature, content, format, and style of reports desired by EMC personnel. Inspection team identifiers and requested field report format specifiers are provided as user-selectable data entry fields within the event setup GUI. An event identifier is received, which is utilized both by the event manager as well as by persons viewing the object record as the unique record identifier. Following retrieval of the layered geospatial visual portrayals and field surveillance attribute data, the event setup application associates the respective layered geospatial visual portrayal and field surveillance attribute data retrieved from the field assessment database with the unique event identifier entered in association therewith.

US Patent application publication No. 2008/0307498 discloses access control for server based geographic information systems (GIS) implemented in a geospatial decision management system (GDMS). An access control operation implements an access control and receives a tile request in receiving operation from a client device for the GIS data. In order to present a geo-visualization interface, all of the data must have a reference to a particular geospatial coordinate which are generally broken down in units of map tiles. Once a tile request is received, the access control module may next identify a bounding box containing all of the tiles in the tile request in an identification operation. Creation of a bounding box allows the access control module to determine whether access is restricted to presentation of any of the map tiles requested. The access control module compares whether any of the entire region of the bounding box intersects with a geospatial attribute that may be subject to a presentation restriction. If the access control module recognizes that there is a restriction associated with one or more of the tiles in the bounding box, the access control module may determine what kind of geospatial attribute is implicated in the bounding box restriction in the checking operation. Sub-modules are invoked to determine whether an actual restriction must be imposed on the data request pursuant to geospatial attributes in the determination operation. This operation determines whether the requested geospatial data set or feature actually conflicts with the restriction set by the data contributor. For example, the tile request at a resolution value restricted by the data contributor without additional authorization or payment then the tile will be considered actually restricted. Alternately, if the tile request is at a resolution value within allowable bounds set by the contributor then the attribute of the request would not be considered restricted and the tiles or associated data would be approved for presentation in a sending operation. For example, if the resolution requested is restricted, the GDMS may return a data set associated with the tiles in the same geographical area as a bounding box, but at a lower, unrestricted resolution.

What is needed in the art is machine implemented method of dynamic suppression of individual data elements within an integrated, multi-element geo-spatial graphical overlay to facilitate role-based, task-based, or other parameter-based denial of content on decision support displays in crisis management scenarios.

### SUMMARY OF THE INVENTION

The present invention provides a dynamic suppression of individual data elements within an integrated, multi-element geo-spatial graphical overlay to facilitate role-based, task-based, or other parameter-based denial of content on decision support displays in crisis management scenarios.

The invention in one form is directed to a method of cloaking data including the steps of recognizing a combination of unclassified information becoming classified as a result of the combination of the information; and cloaking of a portion of the information responsive to a classified authorization of at least one of receiving equipment and users. The recognizing step and the cloaking step being carried out by a data handling machine.

An advantage of the present invention is that the machine operational method evaluates streams of information and dynamically suppresses data elements that are too sensitive to be provided to a receiving equipment or individuals.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram illustration of an embodiment of the present invention;

FIG. 2 is another block diagram further illustrating details of the present invention;

FIG. 3 is yet another block diagram further illustrating details of the present invention;

FIG. 4 is still another block diagram further illustrating details of the present invention;

FIG. 5 is yet still another block diagram further illustrating details of the present invention; and

FIG. 6 is yet still another block diagram further illustrating details of the present invention.

Corresponding reference characters indicate corresponding parts throughout the several views. The exemplifications set out herein illustrate an embodiment of the invention, in one form, and such exemplifications are not to be construed as limiting the scope of the invention in any manner.

### DETAILED DESCRIPTION OF THE INVENTION

Referring now to the drawings, the present invention relates generally to a method of dynamic data cloaking of geo-spatial information and a dynamic data cloaker apparatus carrying out the method for decision-focused displays of complex information. The method implements a dynamic suppression of individual data elements within an integrated, multi-element geo-spatial graphical overlay to facilitate role-based, task-based, or other parameter-based denial of content on decision support displays in crisis management scenarios. The methods described herein are implemented in individual computer assets as well as across network assets. The methods may be carried out in software, hardware or a combination thereof.

The invention generally relates to a dynamic data cloaking of geo-spatial information which includes: 1) the generation of a display layer element attribute table, 2) the generation of a user aperture object model, 3) the generation of a element-level render suppression codes; 4) the assignment of the render suppression codes to modified display layer elements; and 5) the validation of the modified display layer for use by the intended user.

The present invention is a dynamic data cloaker, which, for example is configured to manage data for decision-focused displays of complex information. An implementation of the invention includes the dynamic suppression of individual data elements within an integrated, multi-element geo-spatial graphical overlay to facilitate role-based, task-based, or other parameter-based denial of content on decision support displays in crisis management scenarios.

The method of the invention provides a Dynamic Data Cloaker For Decision-focused Displays Of Complex Information that takes as input a prepared graphical layer of geo-spatial information and that layer's individual content element information. The Data Cloaker considers the role of the registered user or operator of the display system to which the graphical layer is routed for display and action, to thereby select the data provided to the user or operator. Another input to the method of the present invention includes the physical security and network security characteristics of the display system to which the graphical layer is routed for display and action. Yet another input is the information assurance, security clearance and networthiness certification level of the operator as well as the display system to which the graphical layer is routed for display and action. The method of the present invention uses a rule table associating aggregated display content with resultant security classification of the display layer.

The Dynamic Data Cloaker produces as an output a modified graphical layer that invokes a suppression of rendering of selected elements within the input display layer on the targeted destination display system.

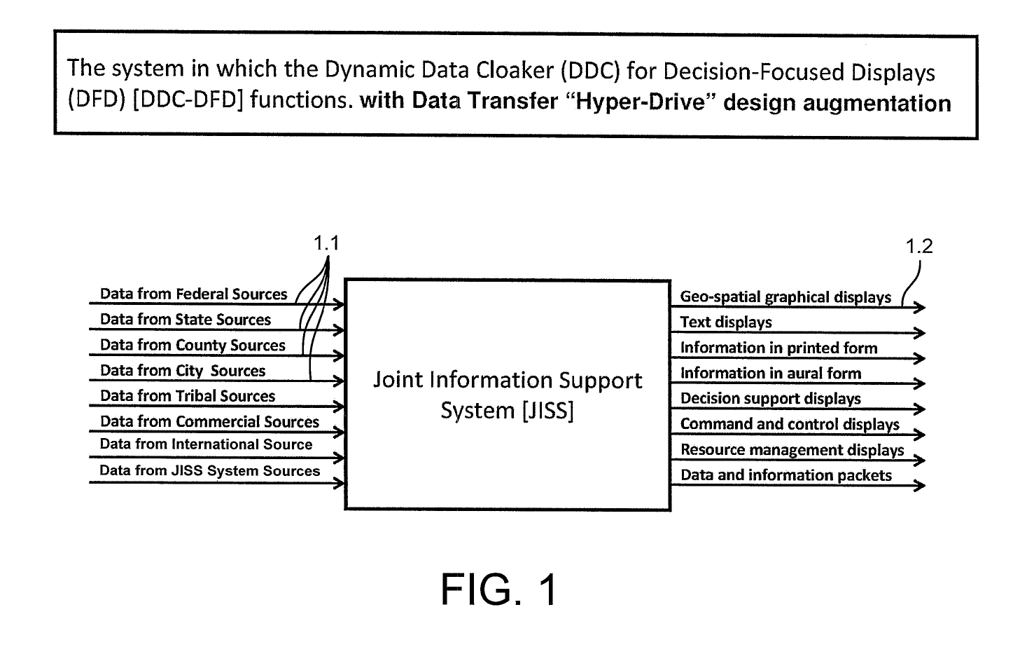

Now, specifically referring to FIG. 1 there is shown an embodiment of the present invention highlighting the larger system in which this invention operates. The inputs-processes-outputs of the command and control decision support system within which the Dynamic Data Cloaker for Decision-Focused Displays [DDC-DFD] of the present invention operates as a vital information security feature in command center environments. The system takes in a myriad of real-time data and transforms the data into role-oriented common operational displays to enhance the management of man-made and natural disasters. The outputs of the system include graphical displays with aural, visual graphic, visual text and pure data stream forms not directly used by human elements of the system but essential for computer-mediated operations of the system such as simulation initiation or simulation stimulation.

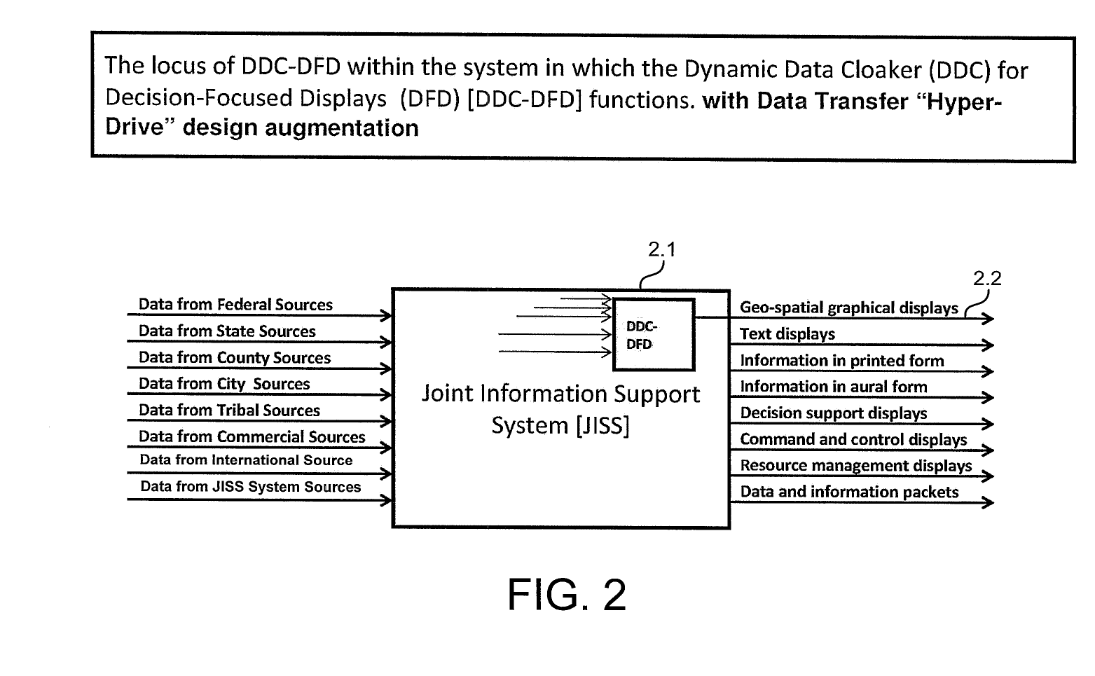

Now, additionally referring to FIG. 2 is a block diagram illustrating the overall system context in which the DDC-DFD operates. The DDC-DFD fills a critical functional gap in current decision support and information fusion systems supporting full spectrum mission operations during crisis situations. The system is presented with an immense, continuous data stream comprised of data at various individual classification levels, each requiring a specific level of protection during transfer and access during dissemination to operators of the system. The level of protection is largely based on the role of the user and the physical and information security attributes of the computer processors, communications networks and display systems. The present invention offers transformational levels of information protection assurance and cyber-security to information packaged for consolidated display over geo-spatial images. The crux of the problem solved by the present invention is that the data has individual security requirements as well as additional, always higher, protection needs when aggregated into displays of collective layer features usually called display layer elements or resources. The Applicant uses these terms interchangeably as they are used that way by industry and operational users. For example, a graphical overlay containing roads, surface structures, power lines, sewer lines forms a benign display layer with virtually no sensitivity to the role of the display observer. However, when you combine location information on convicted felons, molesters and pedophiles aligned with the infrastructure, the composite layer becomes classified Law Enforcement Sensitive (LES) and may not necessary be viewable in the aggregate by certain command center positions or by first responders taking assignments from the command center. The first responders may need the infrastructure information in the layer when it is forwarded to their communication device in the field but the LES information must be suppressed from being rendered on the display.

Prior art approaches fail to adequately address the issue and result in serious operational issues as they utilize separate layers dedicated to the containment of the sensitive data but do not deal with data combinations that as a result of the combination alter the classification of the composite data to levels above that of any of the individual layer resource/element classifications. This layer segregation increases communication bandwidth needs, display data transmission delays and user processor loads to the point where data loses its value/relevance or, at worst, loses its temporal referential integrity to other data over which it lays causing severe distortion in the composite display, which can result in less than optimal decisions on the part of human decision makers counting on accurate, time-coherent display elements.

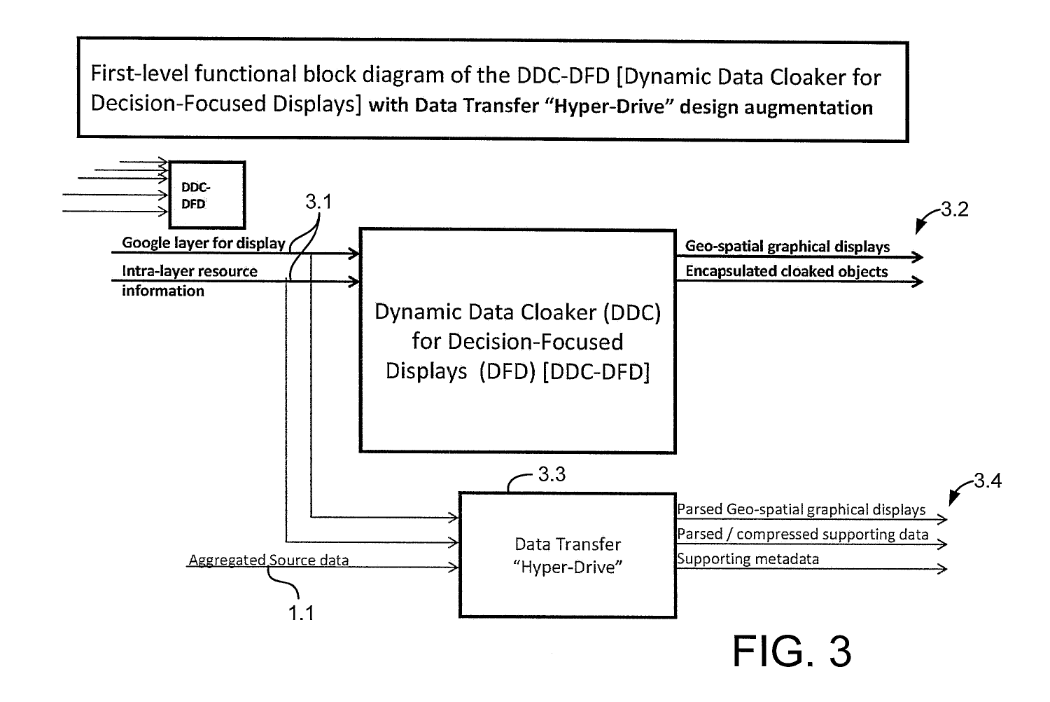

Now, additionally referring to FIG. 3, there is shown a block diagram illustrating the overall input-process-output diagram for the Dynamic Data Cloaker. This is the first level of a functional decomposition of the DDC-DFD. The invention takes the output of the graphical display generator in the legacy system and the associated table of resource/element attributes within that layer to be displayed over geo-spatial under-lays and transforms them into user-appropriate, security compliant versions by encapsulation (cloaking) unauthorized content elements through an assignment of rendering suppression codes at the individual element level within the affected layer.

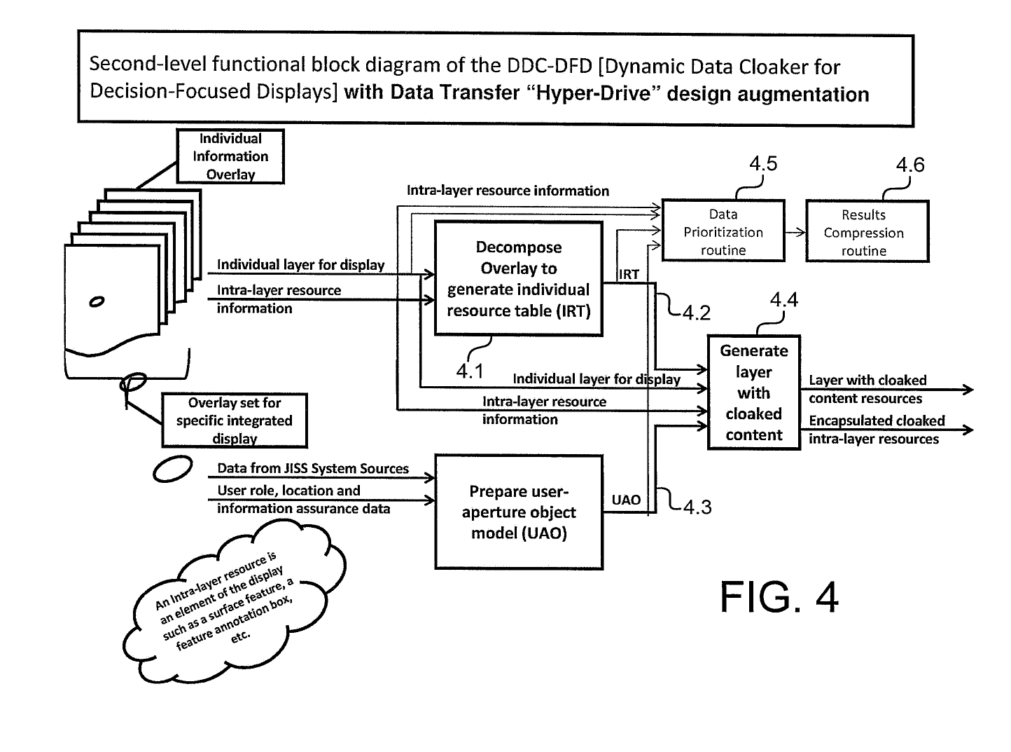

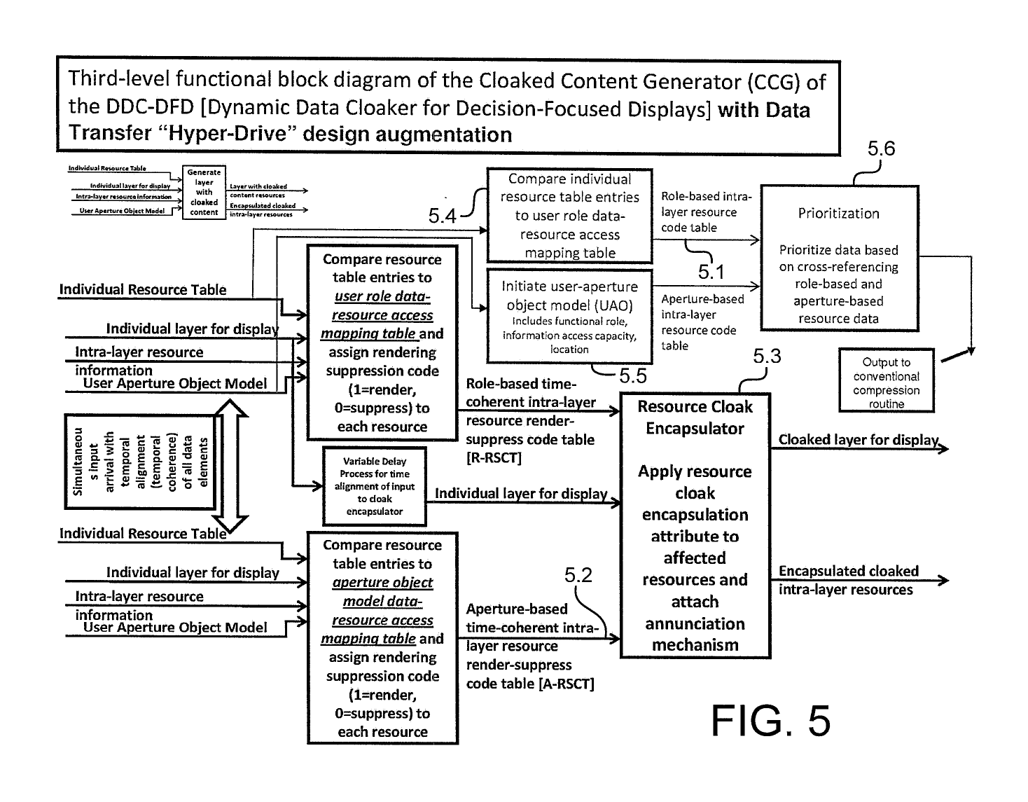

Now, additionally referring to FIG. 4 there is shown a block diagram illustrating sub-components associated with graphical layer decomposition and aperture object model generation. This second-level functional decomposition diagram features the DDC-DFD activities associated with decomposing/deconstructing the basic layer input from the display generator and simultaneously generating a user aperture object model characterizing the role of the user and the user's security clearance attributes as well as the information assurance, networthiness certification of the user's display, processor and network connectivity parameters for use in determining content display authority limitations. This user aperture object model is stored in the system after the first time it is generated and only modified when the source data changes. The data changes may be sensed by an object model currency maintenance feature within this component of the DDC-DFD. The outputs of these two activities are fed to the activity associated with generation of the modified display layer with cloaked content, which is highlighted in FIG. 5.

Now, additionally referring to FIG. 5 there is shown a block diagram illustrating sub-components associated with display layer element suppression code determination and assignment. These components of the DDC-DFD produce the modified graphical layer with encapsulated resources/elements effectively cloaked or suppressed from rendering at the intended user display. This graphical layer state is achieved by the action of dual-concurrent comparators applying rendering suppression codes at the individual layer resource/element level based on either a role-based denial of access model or a user aperture object model conditional (Boolean) assessment that the combinatorial content of the display layer results in higher content protection requirement. The combined outputs of the two comparators and a time-delayed copy of the original non-cloaked display layer are sent to the layer resource/element encapsulation activity for a suppression code application at the resource/element level, as required.

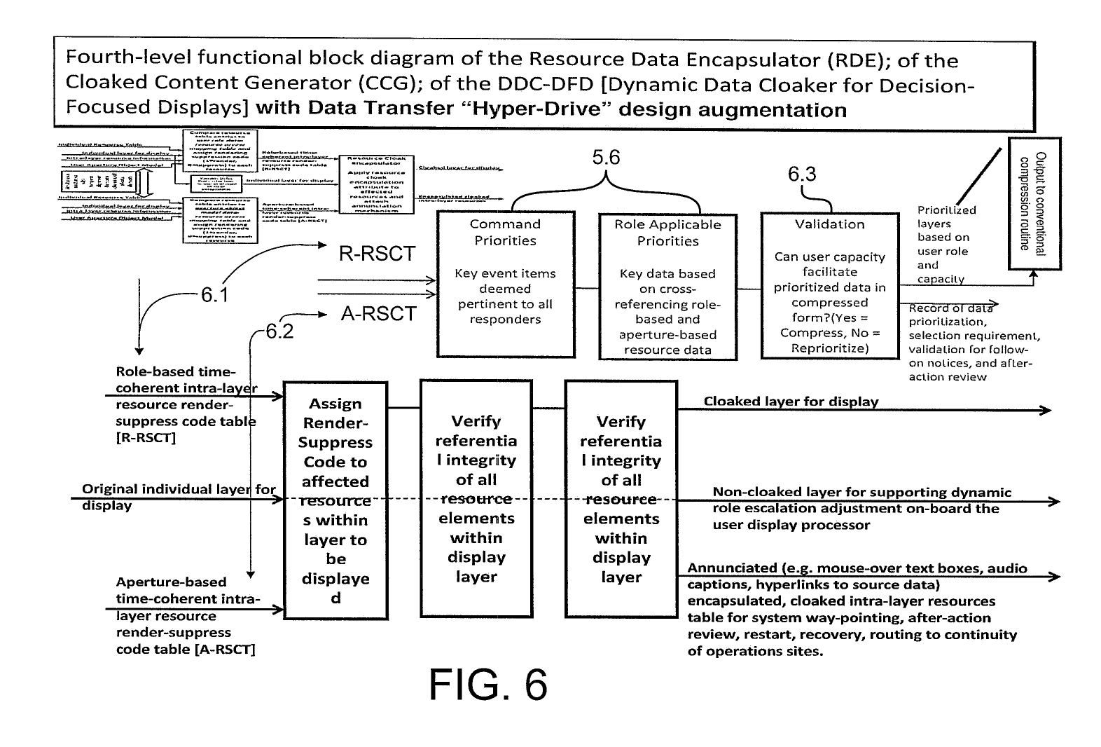

Now, additionally referring to FIG. 6 there is shown a block diagram illustrating sub-components associated with display layer element encapsulation and output verification and integrity checking. This diagram shows the activities associated with final preparation, validation, verification, annotation by annunciation and publication of the cloaked layer back to the display dissemination components of a legacy system. These activities are accomplished by steps that may be sequential in nature and include the assignment of: 1) a suppression code attribute to each element/resource row in the display layer resource table; 2) verification that the referential integrity (traceability of data element pedigree) has been maintained throughout processing within the DDC-DFD; and 3) generate and apply via an appropriate mechanism or media within the composite display layer to annunciate that this is a cloaked layer with the data elements that follow being cloaked.

By way of an example that discusses an information flow and invocation of cloaking functions within the DDC-DFD, references to elements in the figures are identified with the figure number followed by a decimal point and sub-index number to identify the specific function or data element being discussed. e.g. 1.1 is the first referenced element in FIGS. 1 and 1.2 is the second referenced element in FIG. 1.

In this example an Intelligence Analyst assembles an evacuation plan for Galveston, Tex. as a hurricane approaches. The Analyst works with the State Emergency Operations Center (EOC) to provide a composite graphical overlay that has been assembled using a combination of federal, state, county and city databases 1.1. The overlay is known to contain data elements which are law enforcement sensitive, data elements which are needed by medical personnel, and data which are needed by transportation authorities to plan evacuation routes including the types of vehicles to be used. This overlay of geo-spatial information is present as an integrated layer as a part of Joint Information Support System (JISS). An objective of the DDC-DFD is to apply cloaking attributes to the data elements to allow role-based data display suppression codes to elements of the overlay that are carried forward as the overlay is transmitted and used among the decision makers and the first responder team members. The cloaked layer is be present at geo-spatial graphical displays 1.2 and 2.2, which are the same point in the hierarchical display of system functionality and information flow.

The uncloaked layer exists at input 3.1, a Google layer for display 3.1, and the cloaked layer is generated by the DDC-DFD providing cloaked geo-spatial graphical displays 3.2. Concurrently, in FIG. 3 input data 3.1 and the aggregated source data 1.1 are presented to a Data Transfer Hyper-Drive 3.3 functional grouping within the DDC-DFD. The Hyper-Drive functional grouping is intended for role and aperture-focused down-selection of cloaked intra-layer geo-spatially referenced data for shipping time sensitive, mission essential information to first responders under severely degraded communications conditions. Hyper-Drive outputs at 3.4 comprise prioritized display information with conformal referential links to their cloaked counterparts being generated in the DDC-DFD elements of the block diagrams. FIG. 4 highlights the functionality within the DDC-DFD that sequentially decomposes the composite layer existing at 4.1 into an Individual Resource Table (IRT) 4.2, which has a row of attributes for each resource/element of the display layer. These attributes include security constraint parameters explicitly relating to the conditions of human operators and computer/network security assets under which the data may be displayed. If the human operators or the computer/network lack security to meet that which is required by the attributes then suppression of the data at the displays results. Substantially simultaneously, a user-aperture object model (UAO) 4.3 is generated from tables within the Emergency Operations Center facilities and users databases and presented as input to software module “Generate layer with cloaked contents” 4.4 for comparison to layer data element attributes fed into generator 4.4. FIG. 4 also highlights the Data Prioritization Routine, 4.5, needed to develop and assign additional priority attributes to resources within display layers. These priority attributes are necessary to determine the sequence of layer transmissions to display users when communications links are degraded and only limited transmission throughput is available. The Results Compression Routine, 4.6, may be comprised of conventional compression algorithms compatible with the transport layer protocols of the selected transmission medium (e.g. TCP, UDP, PPP).

FIG. 5 highlights the internal operations that generate the cloaked layer to assign the rendering suppression code to each individual element/resource within the layer being assessed for cloaking. Two simultaneous processing paths are used to run a comparison of the element-level security requirements, as expressed by the IRT, to the operator and equipment security attributes as expressed in the user-aperture object model. Whenever display criteria are not met the comparator assigns a render suppression code value of “0” (zero) to the affected element within the display layer. The comparators produce the Role-based time-coherent intra-layer resources render-suppress code table [R-RSCT] and Aperture-based time-coherent intra-layer resource render-suppress code table [A-RSCT] at 5.1 and 5.2 concurrently. These inputs are presented to a Resource Cloak Encapsulator (RDE) 5.3 whose operation is highlighted in FIG. 6. FIG. 5 also highlights the internal comparator architecture (5.4 and 5.5) and data interchange necessary to derive the two governing data tables for resource and layer prioritization in a Prioritization element 5.6 is further detailed in FIG. 6. The functions of 5.4 and 5.5 also include maintenance of temporal coherency and referential integrity of the priority-tagged resources and layers to prevent loss of synchronization with the DDC-DFD activities 5.1, 5.2 and 5.3 that are concurrently preparing the render-suppression codes.

The DDC-DFD RDE 5.3, as further illustrated in FIG. 6, takes the R-RSCT and A-RSCT and reintegrates them into the original format of the inputted graphical display overlay with augmented content in terms of the render-suppression codes, verifies that no path information back to source data was distorted for any element of the display layer. Additionally, the DDC-DFD RDE 5.3 applies annunciation that is displayed as visual or aural cues to viewers of the cloaked display that they are viewing a display with suppressed data elements. The cloaked layer is now adequately prepared for forwarding along the appropriate channels of decision makers and emergency responders with role and aperture-based protection in place to prevent compromise of information, such as pedophile locations being presented to non-law enforcement cleared operators, while still allowing residents with special medical conditions/needs to be presented to medical teams. Information such as road closures due to flooding would likewise be suppressed to medical teams as irrelevant to their mission. However medical needs of victims as well as road closure information would be presented to transportation and vehicle planners and would be rendered on the screens of those planners. FIG. 6 also highlights the algorithmic nature of the assignment of command and role-based prioritization to both the display layers and the resources within those layers. Note the shared inputs (6.1 and 6.2) of the Hyper-Drive activities and the DDC-DFD activities and a Validation element 6.3 of the final Hyper-Drive output formulation to guarantee that the applications of the prioritization codes and the render-suppression codes are time-aligned to prevent temporal-splits within a given display presented to a user.

The Dynamic Data Cloaker for Decision-Focused Displays [DDC-DFD] advantageously operates as a vital information security feature in command center environments. The system takes in a myriad of real-time data and transforms them into role-oriented common operational pictures for management of man-made and natural disasters. The outputs of the system consist of graphical displays with aural, visual graphic, visual text and pure data stream forms not directly used by human elements of the system but essential for computer-mediated operations of the system such as simulation initiation or simulation stimulation. The DDC-DFD fills a critical functional gap in current decision support and information fusion systems supporting full spectrum mission operations during crisis situations. The system is presented with an immense, continuous data stream consisting of data at various individual classification levels, each requiring a specific level of protection during transfer and access during dissemination to operators of the system, largely based on the role of the user and the physical and information security attributes of the computer processors, communications networks and display systems. The present invention offers transformational levels of information protection assurance and cyber-security to information packaged for consolidated display over geo-spatial images.

The present invention also advantageously takes the output of the graphical display generator in the legacy system and the associated table of resource/element attributes within that layer to be displayed over geo-spatial under-lays and transforms them into user-appropriate, security compliant versions by encapsulation (cloaking) unauthorized content elements through assignment of rendering suppression codes at the individual element level within the affected layer.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of cloaking data, comprising the steps of:
recognizing a combination of unclassified data sets becoming classified as a result of the combination of the data sets; and
cloaking of a portion of the data sets responsive to a classified authorization of at least one of receiving equipment and users to which the combination of the data sets is to be directed, the recognizing step and the cloaking step being carried out by a data handling machine.

2. The method of claim 1, wherein the data sets include at least one data set containing geospatial data.

3. The method of claim 2, wherein the cloaking step includes at least one of removing the portion of the data sets, encapsulating the portion of the data sets and encoding the portion of the data sets.

4. The method of claim 1, wherein the data sets reside solely on said data handling machine.

5. The method of claim 1, wherein the data sets are distributed over a plurality of data handling machines.

6. The method of claim 1, wherein said cloaking step includes the step of generating render suppression codes, said render suppression codes being applied to at least a portion of the data in the data sets.

7. The method of claim 6, wherein said render suppression codes are determined by way of one of a code table and an algorithm structure in one of a firmware and a software application.

8. The method of claim 3, wherein said encoding of the portion of the data sets is dependent upon a role of a user of the data sets.

9. The method of claim 3, wherein said encoding of the portion of the data sets is dependent upon network security characteristics between a sender and a receiver of the data sets.

10. The method of claim 9, wherein said encoding of the portion of the data sets is additionally dependent upon changes in network paths between the sender and the receiver.

11. The method of claim 3, wherein said encoding of the portion of the data sets is dependent upon security characteristics of at least one of a receiving computer and a display system communicatively connected to said receiving computer.

12. The method of claim 11, wherein said encoding of the portion of the data sets is periodically adjusted as the security characteristics of said receiving computer and said display system change.

13. The method of claim 1, further comprising the step of repeating said recognizing step and said cloaking step.

14. A method of cloaking data, comprising the steps of:
combining a plurality of selected unclassified data sets;
detecting that said combined data sets have become classified as a result of said combining step; and
cloaking of a portion of said combined data sets responsive to a classified authorization of at least one of receiving equipment and users to which said combined data sets is to be directed, the detecting step and the cloaking step being carried out by a data handling machine.

15. The method of claim 14, wherein the data sets include at least one data set containing geospatial data.

16. The method of claim 15, wherein the cloaking step includes at least one of removing the portion of the data sets, encapsulating the portion of the data sets and encoding the portion of the data sets.

17. The method of claim 14, wherein the data sets reside solely on said data handling machine.

18. The method of claim 14, wherein the data sets are distributed over a plurality of data handling machines.

19. The method of claim 14, wherein said cloaking step includes the step of generating render suppression codes, said render suppression codes being applied to at least a portion of the data in the data sets.

20. The method of claim 14, further comprising the step of repeating said combining step, said detecting step and said cloaking step.
